(19) United States
(12) Patent Application Publication
(10) Pub. No.: US 2011/0107636 A1
(43) Pub. Date: May 12, 2011

(54) Exhibitor Number Display System

(76) Inventor: Erwin Bruner, Wellington, FL (US)

(21) Appl. No.: 12/614,133

(22) Filed: Nov. 6, 2009

(51) Int. Cl. G09F 7/02; B68C 1/12

(52) U.S. Cl. 40/620

(57) ABSTRACT

An equestrian identification system that includes a series of numbered panels that are attached to a panel receiving patch. A dense hook interface is provided upon an interface surface of the numbered panels. A dense loop interface is provided upon an interface surface of the panel receiving patch. The panel receiving patch is applied to a proper area of a saddle pad, an equestrian's attire, or other allowable object. The numbered panels are provided in a plurality of sets, each set being numbered from 0 through 8. The number of sets are respective to the number of digits required for identification; usually either three or four. The panel receiving patch can be colored to match or compliment the object to which is it being applied thereon.

### FIELD OF THE INVENTION

The present disclosure generally relates to an apparatus and method for identifying an equestrian participant. More particularly, the present disclosure relates to a numbering apparatus for changeably displaying a series of digits for an equestrian event.

### BACKGROUND OF THE INVENTION

They are also used in competitive sports including, but not limited to, dressage, endurance riding, eventing, reining, show jumping, tent pegging, vaulting, polo, horse racing, driving, and rodeo. (See additional equestrian sports listed later in this article for more examples.) Some popular forms of competition are grouped together at horse shows, where horses perform in a wide variety of disciplines.

There are many Equestrian events. Sporting events are substantiated when they are included in the Olympic games. Equestrian events were first included in the Olympic games in 1900. By 1912, all three Olympic disciplines, still seen today, were part of the games. The following forms of competition are recognized worldwide and are a part of the equestrian events at the Olympics:
Dressage (“training” in French) involves the progressive training of the horse to a high level of impulsion, collection, and obedience. Competitive dressage has the goal of showing the horse carrying out, on request, the natural movements that it performs without thinking while running loose. One dressage master has defined it as “returning the freedom of the horse while carrying the rider.”
Show jumping comprises a timed event judged on the ability of the horse and rider to jump over a series of obstacles, in a given order and with the fewest refusals or knockdowns of portions of the obstacles.
Eventing, also called combined training, horse trials, the three-day event, the Military, or the complete test, puts together the obedience of dressage with the athletic ability of show jumping, the fitness demands the cross-country jumping phase. In the last-named, the horses jump over fixed obstacles, such as logs, stonewalls, banks, ditches, and water, trying to finish the course under the “optimum time.” There was also the ‘Steeple Chase’ Phase, which is now excluded from most major competitions to bring them in line with the Olympic standard.

Additional events sanctioned by the FEI as international disciplines include combined driving, reining, equestrian vaulting, endurance riding and paralympic competition. While these events are recognized internationally and are all part of the FEI World Equestrian Games, none are yet part of the Summer Olympics, though some, such as vaulting and reining, are potentially on track to be added.

Participants of the various equestrian events are identified by a numeric identifier. The numeric identifier is generally a series of three (3) or four (4) numeric digits displayed upon a saddle pad. The printed display sheets are pre-printed, with a pair of matching sheets provided to the participant at the start of an event. The standard practice is to provide the participant with a printed display sheet that is inserted into a transparent sleeve. The printed display sheet is normally paper, which is subject to damage when wet. The sleeves can discolor or tear. Alternately, the display sheets can be pinned to the saddle pads, which risks tearing during the event.

Therefore, a numeric identifier, which is weatherproof, available to the participant in advance, and is secured throughout the event, is needed.

### SUMMARY OF THE INVENTION

The present disclosure is generally directed to a device and respective system for identifying an equestrian event participant.

In some embodiments, the identification system may include:
a series of numbered panels comprising a dense hook on a mounting surface; and
a panel receiving patch being sized to receive at least two numbered panels, the receiving patch having a dense loop surface.

In another aspect, the series of numbered panels comprise a set of numbered panels being numbered between 0 and 8, wherein the 6 and the 9 are interchangeable.

In still another aspect, the series of numbered panels comprise a plurality of sets of numbered panels, each set being numbered between 0 and 8.

While yet another aspect places a plurality of numbered panels adjacent each other.

In yet another aspect, the images of the numbers are printed upon an exposed surface of the numbered panels.

In a still further aspect, the images of the numbers are embroidered upon the numbered panels.

In another aspect, the panel receiving patch is colored to match the surface in which it is to be applied upon.

Continuing with another aspect, the panel receiving patch is applied to a saddle pad.

In a still further aspect, the panel receiving patch is applied to an equestrian riding jacket.

In yet another aspect, the panel receiving patch is applied to a sleeve or rear of the equestrian riding jacket.

These and other aspects, features, and advantages of the present invention will become more readily apparent from the attached drawings and the detailed description of the preferred embodiments, which follow.

### BRIEF DESCRIPTION OF THE DRAWINGS

The invention will now be described, by way of example, with reference to the accompanying drawings, where like numerals denote like elements and in which:

FIG. 1 presents an isometric view of a horse having a participant numeric identifier in accordance with the known prior art;

FIG. 2 presents a side elevation view of a participant numeric identifier in accordance with the present invention;

FIG. 3 presents a side elevation view of a saddle pad including the participant numeric identifier of FIG. 2; and

FIG. 4 presents an isometric view of an equestrian participant including the participant numeric identifier of FIG. 2.

Like reference numerals refer to like parts throughout the various views of the drawings.

### DETAILED DESCRIPTION OF THE INVENTION

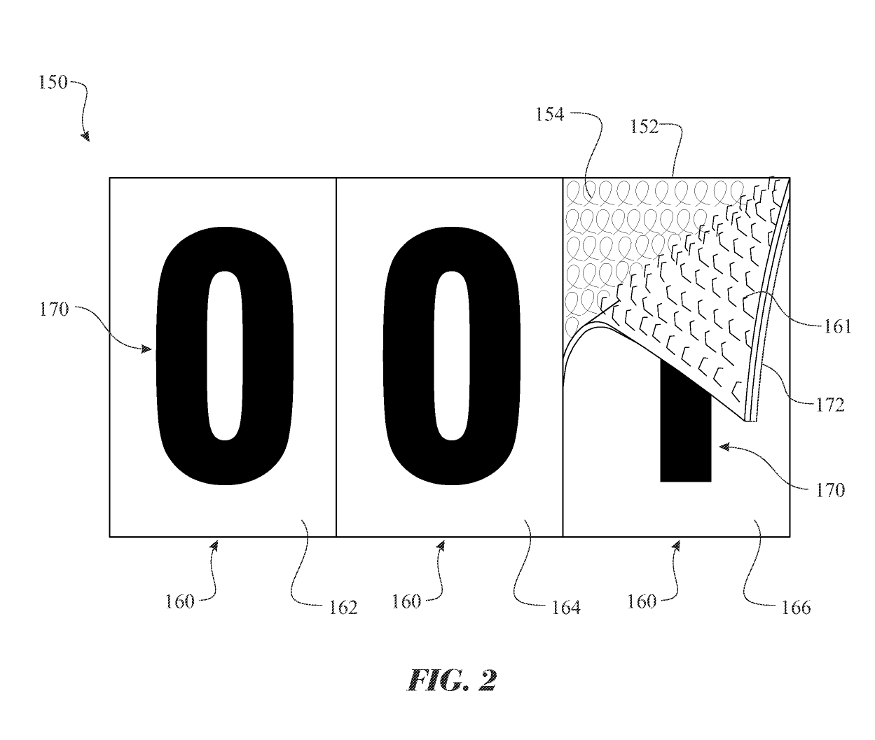

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 2. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

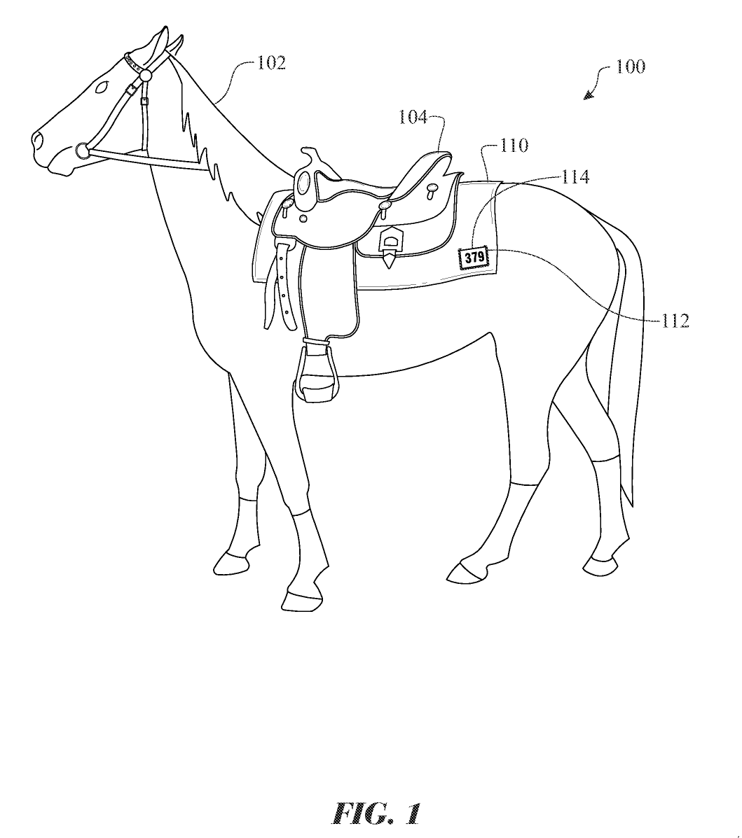

Equestrian sports identify the participants via a numeric identifier. The judges or scoring parties rely of the numeric identifier as a means for identifying the participants or equestrian sporting horses 100 as presented in exemplary illustration of FIG. 1. The equestrian sporting horse 100 is a horse 102 having a saddle 104 placed upon an equestrian sporting horse 100. The currently used identifier is a printed participant identifier 114 inserted into an equestrian participant identifier holder 112 placed upon a saddle pad 110. The printed participant identifier 114 is normally provided as a printed sheet of paper, sized to fit into the equestrian participant identifier holder 112. The equestrian participant identifier holder 112 is preferably provided on each side of the saddle pad 110.

The equestrian participant identifier system 150 provides a numbering identification system comprising a panel receiving patch 152 and a series of numbered panels 160, as illustrated in FIG. 2. Each numbered panel 160 is preferably sized being 2.0″ tall and 1.5″ wide. The preferred panel receiving patch 152 is sized to accept three (3) numbered panels 160 (as shown) or four (4) as understood, being 2″ tall by 4.5″ wide or 2.0″ tall by 6.0″ wide respectively. The panel receiving patch 152 is fabricated having a dense loop interface 154 on an exposed side for removably attaching the numbered panel 160 therefrom. The panel receiving patch 152 can be colored to match or compliment the color of an object to which the panel receiving patch 152 is to be applied upon.

The series of numbered panels 160 includes three (3) (or four as an alternate) sets 162, 164, 166 of numbered panels. Each set of numbered panels are numbered from 0 through 8, wherein the same panel is used for both the “6” and the “9”.

Each numbered panel 160 is formed having a dense hook interface 161 provided upon an attachment side and a numeric image 170 visible from an exposed side. The numeric image 170 includes images representative of the numbers 0 through 8, wherein the same panel is used for both the “6” and the “9”. The numbers can be printed onto the exposed surface using any printing method such as transfer printing, silk screen printing, and the like, embroidered onto the panels 160, or applied by any other known means. Alternately, the printing can be applied to the interface side, wherein the material is transparent, allowing the image to be visible from the viewing side. This would protect the image against stains, bleaching, water, and the like. The numbered panel 160 can be a single material having a dense hook interface 161 on the attachment side, and a relatively planar surface on the opposite site. Alternately, the dense hook interface 161 and the exposed surface can be of separate materials that are assembled together forming a single finished unit. The numeric image 170 can be applied to the exposed surface material 172 prior to or subsequent the assembly process.

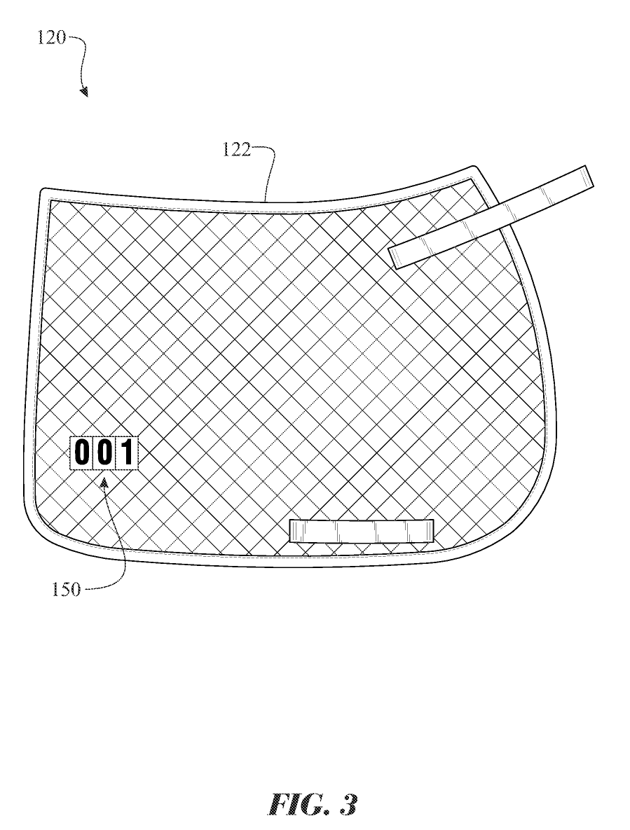

A first exemplary embodiment is presented as a saddle pad assembly 120, being illustrated in FIG. 3. The saddle pad assembly 120 comprises a saddle pad 122 outfitted to adorn the equestrian participant identifier system 150. The panel receiving patch 152 is stitched to, adhered to, or attached via any other attachment means to the saddle pad 122, orienting the dense loop interface 154 outwards for engaging with the dense hook interface 161. By permanently affixing the panel receiving patch 152 to the saddle pad 122 or other garment, the system can be washed, while maintaining the number panels 160 in like-new condition. The panel receiving patch 152 is positioned to meet the regulation of the international equestrian guidelines.

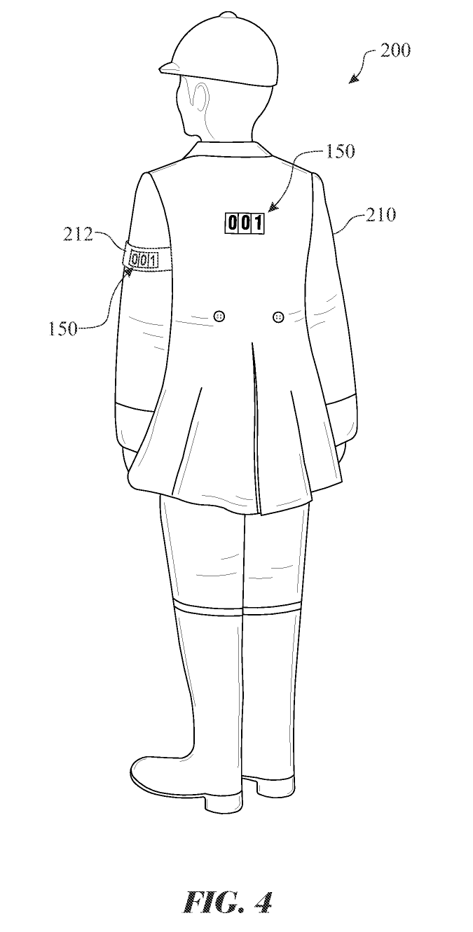

A second exemplary embodiment is presented as an equestrian participant 200, being illustrated in FIG. 4. The equestrian participant 200 is illustrated wearing a participant's attire 210, the participant's attire 210 adorned by the equestrian participant identifier system 150. The panel receiving patch 152 is stitched to, adhered to, or attached via any other attachment means to the participant's attire 210, orienting the dense loop interface 154 outwards for engaging with the dense hook interface 161. The panel receiving patch 152 can be safety pinned to the participant's attire 210, wherein the numbered panels 160 would cover the safety pin. The panel receiving patch 152 is positioned to meet the regulation of the international equestrian guidelines. Since most participants' attire 210 is colored, it is preferable that the panel receiving patch 152 be colored to match or compliment the color of the participant's attire 210. Alternately, the equestrian participant identifier system 150 can be applied to an armband 212 in a similar manner.

The equestrian participant identifier system 150 provides the user with a means for identifying an exhibitor or show participant. The system 150 allows the user to create their own identifier, as opposed to obtaining a preprinted paper version. Should the number become damaged or lost, the user can easily replace one or more panels 150. The system 150 is designed to blend into the pad or garment, providing a look and feel of an unmodified item.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An equestrian participant identifier system, comprising:
a panel receiving patch comprising a dense loop interface provided on an interface side of the receiving patch, the panel receiving patch is designed to be attached to an equestrian object; and
a series of numbered panels, the series comprising at least two sets of numbered panels having number images from 0 through 8,
wherein the number image is applied to a viewing side of the numbered panel, and
wherein each numbered panel comprises a dense hook interface on an interface side of the numbered panel.

2. An equestrian participant identifier system as recited in claim 1, wherein the number image is an image that is printed upon the viewing side of the numbered panel.

3. An equestrian participant identifier system as recited in claim 1, wherein the number image is an image that is an embroidery provided such to be viewed from the viewing side of the numbered panel.

4. An equestrian participant identifier system as recited in claim 1, wherein the panel receiving patch is colored to match or compliment an object to which it will be applied.

5. An equestrian participant identifier system as recited in claim 1, wherein the series comprising three sets of numbered panels.

6. An equestrian participant identifier system as recited in claim 5, wherein the panel receiving patch is sized to receive three numbered panels positioned linearly and adjacent one another.

7. An equestrian participant identifier system, comprising:
a panel receiving patch comprising a dense loop interface provided on an interface side of the receiving patch, the panel receiving patch being attached to an equestrian object with the interface side being exposed, wherein the equestrian object is selected from a group consisting of:
a) a saddle pad,
b) an equestrian participant's attire, and
c) an armband; and
a series of numbered panels, the series comprising at least two sets of numbered panels having number images from 0 through 8,
wherein the number image is applied to a viewing side of the numbered panel, and
wherein each numbered panel comprises a dense hook interface on an interface side of the numbered panel.

8. An equestrian participant identifier system as recited in claim 7, wherein the number image is an image that is printed upon the viewing side of the numbered panel.

9. An equestrian participant identifier system as recited in claim 7, wherein the number image is an image that is an embroidery provided such to be viewed from the viewing side of the numbered panel.

10. An equestrian participant identifier system as recited in claim 7, wherein the panel receiving patch is colored to match or compliment an object to which it will be applied.

11. An equestrian participant identifier system as recited in claim 7, wherein the series comprising three sets of numbered panels.

12. An equestrian participant identifier system as recited in claim 11, wherein the panel receiving patch is sized to receive three numbered panels positioned linearly and adjacent one another.

13. An equestrian participant identifier method, comprising:
applying a panel receiving patch to an equestrian object, wherein the equestrian object is selected from a group of equestrian objects consisting of:
a) a saddle pad,
b) an equestrian participant's attire, and
c) an armband; and
wherein said panel receiving patch comprises a dense loop interface provided on an interface side of the receiving patch and the panel receiving patch is attached with the interface side being exposed;
removably attaching at least one numbered panel to the panel receiving patch wherein the at least one numbered panel is selected from a series of numbered panels, the series comprising at least one set of numbered panels, each panel uniquely numbered, having a number image ranging from 0 through 8, the number image being applied to a viewing side of the numbered panel, and
identifying an equestrian participant using the number image provided in the at least one numbered panel.

14. An equestrian participant identifier method as recited in claim 13, the method further comprising a step of removably attaching at least two numbered panels adjacent one another to form an at least two digit number.

15. An equestrian participant identifier method as recited in claim 14, the method comprising the steps of:
applying a pair of panel receiving patches, one to each side of a saddle pad; and
selecting a pair of at least one numbered panels, the numbered panels identifying an equestrian participant's numeric identifier.
removably attaching each of the pair of at least one numbered panels to each of the two panel receiving patches.

16. An equestrian participant identifier method as recited in claim 13, the method further comprising a step of utilizing a number image for both a “6” and a “9”.
